(19) United States
(12) Patent Application Publication
(10) Pub. No.: US 2017/0255926 A1
(43) Pub. Date: Sep. 7, 2017

(54) STORED VALUE DESIGN AND DISTRIBUTION PORTAL

(71) Applicant: GIFT CARD IMPRESSIONS, LLC, Kansas City, MO (US)

(72) Inventors: Brett Glass, Kansas City, MO (US); Karl Geisler, Kansas City, MO (US)

(21) Appl. No.: 15/430,161

(22) Filed: Feb. 10, 2017

Related U.S. Application Data
(60) Provisional application No. 62/303,833, filed on Mar. 4, 2016.

(51) Int. Cl. G06Q 20/34

(52) U.S. Cl. CPC G06Q 20/348

(57) ABSTRACT

A stored value design and distribution portal includes a computer-executable service that exposes a sponsor portal interface for receiving user supplied information for customizing a stored value card from a sponsor of the stored value card, and generates a stored value card design using the user supplied information in which the stored value card design is stored in a repository. Once generated, the service then publishes, using one or more second portal interfaces, the stored value card design for purchase as a stored value card by a consumer from the repository, and transmits the stored value card to the consumer.

### RELATED APPLICATIONS

This application claims priority to U.S. Provisional Patent Application No. 62/303,833, filed on Mar. 4, 2016, and entitled “Stored Value Design and Distribution Hub.” The contents of 62/303,833 are hereby incorporated by reference in their entirety.

### FEDERALLY SPONSORED RESEARCH OR DEVELOPMENT

Not Applicable.

### COMPACT DISK APPENDIX

Not Applicable.

### FIELD OF INVENTION

The present invention generally relates to stored value cards, and more particularly, to a stored value card design and distribution hub.

### BACKGROUND

Transaction cards, stored value cards, or stored value cards as they are commonly called based upon their intended use, have become popular gifts. Gift cards typically comprise a stored value card whereby a certain cash equivalent value is encoded upon a magnetic strip applied to the surface of the card. This stored value is determined by the vendor prior to packaging and display for sale or is selected at the point of sale by the purchaser and loaded by the cashier using a magnetic card reader/writer.

### SUMMARY

According to one embodiment, a stored value design and distribution portal includes a computer-executable service that exposes a sponsor portal interface for receiving user supplied information for customizing a stored value card from a sponsor of the stored value card, and generates a stored value card design using the user supplied information in which the stored value card design is stored in a repository. Once generated, the service then publishes, using one or more second portal interfaces, the stored value card design for purchase as a stored value card by a consumer from the repository, and transmits the stored value card to the consumer.

### BRIEF DESCRIPTION OF THE DRAWINGS

The foregoing and other objects, features and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1A illustrates an example stored value card design and distribution portal according to one embodiment of the present disclosure.

FIG. 1B depicts an example embodiment of a computing device according to one embodiment of the portal.

FIG. 1C illustrates an example data source that may be used by the portal according to one embodiment of the present disclosure.

FIG. 2 is a block diagram depicting an example stored value card design and distribution portal service executing on the stored value card design and distribution portal computing system.

FIG. 3 illustrates an example process that may be performed by the portal service for generating and distributing stored value cards according to one embodiment of the present disclosure.

FIG. 4 illustrates a block diagram of an example computer device for use with the example embodiments of the present disclosure.

### DETAILED DESCRIPTION

Although stored value cards have been become a commonly accepted gifting medium, their use has not been without limitation. For example, conventional stored value cards are generally impersonal in that they typically do not include any personal sentiment that the user (i.e., sender) would like to convey to his or her recipient. Embodiments of the present disclosure provide a solution to this problem using a stored value card design and distribution portal that receives user supplied information for designing a customized stored value card, such as through a first portal interface, such as an application program interface (API), and publishes the customized stored value card for sale through one or more consumer portal interfaces. Thereafter, when a request is made to purchase the stored value card by a customer, the hub manages a financial transaction for purchasing the stored value card, and transmits the stored value card to the customer.

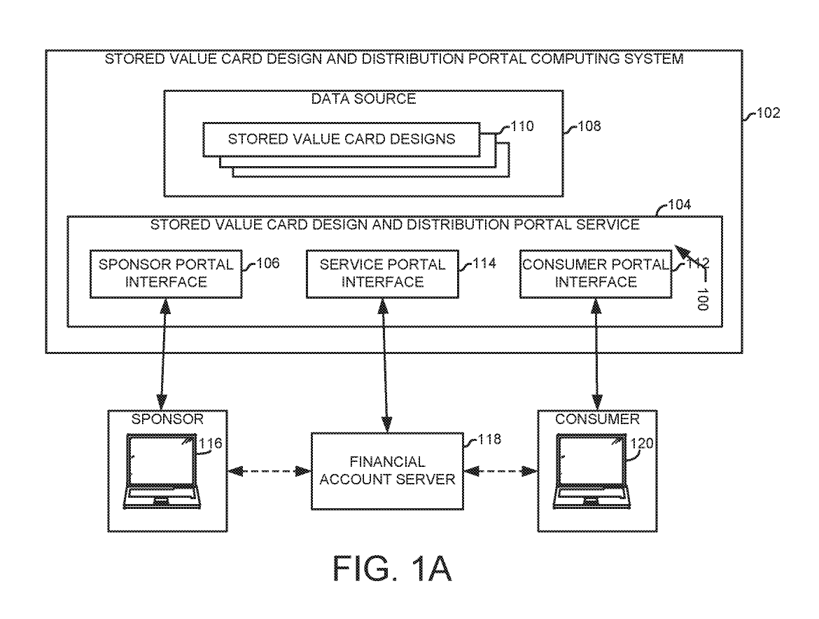

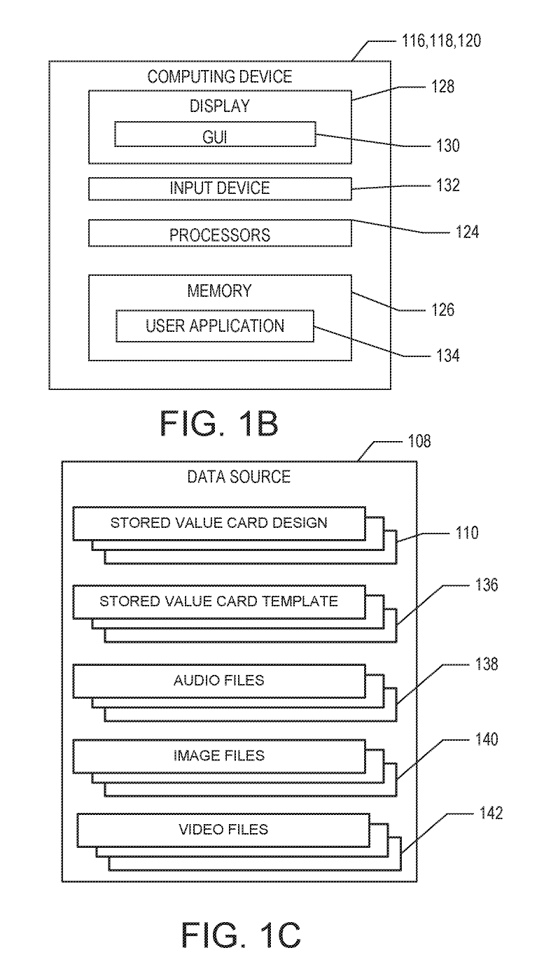

FIG. 1 illustrates an example stored value card design and distribution portal 100 according to one embodiment of the present disclosure. The stored value card design and distribution portal 100 generally includes a portal computing system 102 that executes a stored value card design and distribution portal service 104 that may be used for designing a customized stored value card by a sponsor of that stored value card (e.g., a merchant of a closed loop stored value card) using a sponsor portal interface 104. The stored value card design and distribution portal 100 also includes a data source 108 (e.g., storage repository) for storing stored value card designs 110 that can be published for purchase via one or more consumer portal interfaces 112, and a service portal interface 114 whereby one or more external systems may be accessed for managing a financial transaction for the purchase of a customized stored value card associated with a stored value card design 110 by a consumer.

In general, the portal 100 provides a system for creating, publishing, and purchasing stored value cards from a centralized location, which may be, for example, a single storage location from which to design stored value cards, publish those stored value cards, and/or conduct a transaction for purchase of those stored value cards for purchase by a consumer). Embodiments of the present disclosure may provide benefits not heretofore recognized by conventional stored value card marketing systems. For example, because the stored value card designs are stored and accessed for sale at a common location, enhanced control over quality and data integrity may be maintained. Additionally, ongoing changes (e.g., software upgrades, etc.) performed on the service 102 may be adapted to the designs 110 in a structured organized manner. As another example, protection of the portal 100 from illicit online activity (e.g., hacking) may be enhanced by reducing the level of exposure points that need to be protected via a firewall.

As yet another example, the portal 100 may provide a safe, secure hosting platform for their stored value card offerings.

In one embodiment, the portal 100 is managed by an entity, such as a business organization, that is separate and distinct from merchants who use the portal 100 to design and distribute their stored value card offerings. Thus, merchants may be alleviated from the generic hassles typically associated with the development and marketing of stored value cards. Additionally, since the portal 100 is managed by a separate and distinct entity, a common, centralized repository (e.g., the data source) may be used that is more easily maintained than one in which stored value card information is spread over numerous disparate repositories.

The sponsor portal interface 106 communicates with a computing device 116 of a sponsor, such as a merchant or retailer, to receive information for designing a customized stored value card design 110. The design portal service 104 may customize the stored value card design 110 in any suitable manner. For example, the design portal service 104 may receive user supplied content in the form of alpha-numeric text information from the sponsor, audio content from the sponsor, and/or photographic or video content from the sponsor. Additionally, the design portal service 104 may receive other user supplied information for customizing the stored value card design 110, such as geometric information for defining a shape (e.g., circle, hexagon, triangle, telephone shape, human shape, etc.) of the stored value card, placement of text/imagery information on the stored value card design 110, haptic information to be used with e-stored value cards.

In one embodiment, the design portal service 104 may be used for version control. For example, a merchant may release ongoing versions that track ongoing changes to the merchandise they sell. The design portal service 104 may store multiple versions for each merchant so that they can access earlier versions, or do additional market research using the information stored in multiple versions of the merchant's stored value card offerings.

The customized visuals can be occasion based (e.g., Christmas, Easter, Birthday, etc.). Additionally, custom visuals for the stored value cards 108 can be created to influence redemption on certain products. The stored value card designs 110 can be open or closed loop. The stored value cards 108 can be restricted or non-restricted. For example, a restricted stored value card could restrict a purchase to a specific product or service.

The sponsor portal interface 106 communicates with a computing device 120 of a consumer to process a transaction for activation of a stored value card associated with a stored value card design 110 selected by the consumer. Once published to the consumer portal interface 112, any combination of entities (e.g., consumers that want to purchase from the portal) may, via the consumer portal interface 112, have a stored value card associated with the stored value card design 110 activated. The consumer may then give the stored value card to a person, such as for an occasion as indicated by the user supplied information. That is, the stored value card can be used directly as a stored value card to be provided at no or minimal charge to another party. One or more consumer portal interfaces 112 may be provided for receiving consumer input for purchasing a stored value card. For example, one consumer portal interface 110 may be provided as an e-commerce site to provide for interacting directly with a consumer, while another consumer portal interface 110 may be provided for interacting with a corporate entity for purchasing stored value cards 108 to send to customers, employees, etc. This could be CRM related, HR related, Incentive Related, and the like. As another example, a consumer portal interface 110 may be provided to a distributor of stored value cards (e.g., Gift Card Malls, etc.) to receive the stored value cards and distribute those stored value cards through their established marketing channels. As yet another example, a consumer portal interface 112 may be provide for interacting with a partner entity (e.g., a third party e-gift provider) that partners with the administrator of the portal 100.

In one embodiment, the portal service 104 may publish, using the consumer portal interface 112, the stored value card for use by a third party entity (e.g., a merchant, a stored value card seller, etc.) such that the third party entity exposes the stored value card for purchase by a consumer and conduct a transaction for the stored value card with the consumer. When the transaction has been consummated, the portal service 104 may transmit the stored value card to the consumer, such as via the consumer portal interface 112 to a distributor.

In another embodiment, the portal service 104 may publish the stored value card on a website of a sponsor in a manner that appears seamless to the consumer. That is, the sponsor portal interface 106 may include executable code that allows the sponsor to add the stored value card offering in a manner that makes it appear that the stored value card offering is managed by the sponsor's website.

A service portal interface 114 may also be provided that interacts with one or more external sources, such as a financial account computing system of the consumer or the merchant for managing financial transactions for purchase of the stored value cards 108 by the consumers. In one embodiment, the service portal interface 114 may interact with one or more stored value processing entities (e.g., SVS, First Data, etc.) to activate the stored value card. Thus, the portal 100 may be separate and distinct than a stored value processing entity, which accepts and processes the stored value card transaction.

Embodiments of the present disclosure may provide one or more benefits not heretofore recognized by conventional stored value distribution systems. For example, because the portal service interface 114 allows a stored value processing entity to be directly accessed, a financial transaction can be conducted in a manner that frees the sponsor of the stored value card from managing the transaction, thus enabling the sponsor to focus other aspects of running their business. Additionally, because the financial transaction is conducted through the portal service 104, a single storage repository may be provided for selling a stored value card, which has also been used to develop (e.g., design) the stored value card, so that multiple differing versions of the stored value card may be managed with greater ease and reliability that what otherwise have been provided by conventional systems requiring multiple disparately located storage repositories.

In yet another example, conventional stored value card delivery architectures have often involved time consuming processes to have stored value cards updated and/or exposed. Thus, these conventional stored value card delivery architectures have been relegated to a relatively generic delivery of stored value cards to market, even when not occasion specific. Embodiments of the present disclosure may provide a streamlined process, that makes it easy to change the look, feel, sentiment, style, creativity, and the like of stored value cards, thus allowing sponsors to market and promote stored value designs more efficiently and more impact in some cases. Additionally, whereas traditional stored value delivery systems have been precluded from use by regional or local sponsors (e.g., merchants), embodiments may allow customers of stored value cards to access stored value designs having enhanced local sentiment (e.g., demographically diverse). Thus, sponsors operating in relatively smaller markets may enjoy enhanced localization of their stored value card offerings.

In one example, a merchant wishes to generate a new stored value card design for a new product line they are introducing. The merchant may, using their personal computer, log into the design portal service 104 and interact with the design portal service 104 to customize the new stored value card. For example, the design portal service 104 may display one or more templates that serve as a starting point from which additional customization may be provided. In such a case, the merchant may choose a template having a shape of a phone, and upload additional user supplied information, such as text information and/or artwork to be included on the customized stored value card. The merchant can then upload information associated with an amount of stored value that they would like it to be worth along with corresponding terms and conditions to be associated with the card. The design portal service 104 may perform other actions to ensure publishing is complete. Thereafter, the design portal service 104 may publish the customized stored value card to the portal 106 such that it is available for purchase by one or more customers via the consumer portal interfaces 112.

In summary, the stored value card design and distribution portal 100 may create a marketplace for custom stored value cards that can be accessed and resold through various third party sources. The stored value card design and distribution portal 100 has a design portal service 104 that functions as a front end for merchants to create a custom stored value card using a variety of templates. The stored value card may be customized with photo, text, sound, video, and/or haptic features to create a stored value card that is more than conventional stored value cards in use today. The stored value card design and distribution portal 100 then provides the ability to upload the customized stored value card to a portal that can then be accessed by differing types of customers.

FIG. 1B depicts an example embodiment of a computing device 116, 118, and 120 according to one embodiment of the portal 100. The computing device 116, 118, and 120 is a computing or processing device that includes one or more processors 124 and memory 126 and is to receive data and/or communications from, and/or transmit data and/or communications to, the computing device 102 via a suitable communication network such as described herein above. For example, the computing device 116, 118, and 120 can be a personal computer, such as a laptop or notebook computer, a workstation, or other processing device such as a personal digital assistant or a tablet computer. The computing device 116, 118, and 120 includes a display 128, such as a computer monitor, for displaying data and/or a graphical user interface 130. The computing device 116, 118, and 120 also includes an input device 132, such as a keyboard or a pointing device (e.g., a mouse, trackball, pen, or touch screen) to enter data into or interact with the graphical user interface 130. In one embodiment, the display 128 comprises a touchscreen device in which input is provided via contact by the user with the touchscreen device.

According to one embodiment, the computing device 116, 118, and 120 may include a user application 134 stored in the memory 126 and executed on the processors 124 to generate the graphical user interface (GUI) 130 to the display 128. The graphical user interface 130 enables the computing device 116, 118, and 120 to interact with one or more data entry forms received from the computing device 102 to enter order data for generating the personalized webpage and/or submitting orders to the service 104. In one embodiment, the user application 134 includes a web browser that displays interactive web pages, applets, or other suitable user interface mechanisms including one or more selectable fields, editing screens, and the like for selecting content and/or modifying pre-recorded content by the user (i.e., sender). In another embodiment, the GUI application 134 includes application software (i.e., a mobile app) that is executed on the computing device 116, 118, and 120, which is, for example, a wireless communication device for providing one or more selectable fields, edit screens, and the like for selecting content and/or modifying pre-recorded content by the user.

The data source 108 functions as a centralized repository for storing stored value card designs 110 developed and distributed by the portal 100. As best shown in FIG. 1C, the data source 108 stores customized stored value card designs 110, stored value card templates 136, pre-recorded audio files 138, pre-recorded image files 140, and pre-recorded video files 142. Nevertheless, the data source 108 stores any suitable type of information for customizing a stored value card. The stored value card designs 130 store information that is used for creating a customized stored value card. The stored value card templates 136 store information that may be used to create a customized stored value card design 110. The pre-recorded audio files 138, image files 140, and image files 142 include content that may be selected for inclusion in a customized stored value card design 110. For example, the audio files 138 may include a song or other snippet of sound that can be included in the electronic stored value card or stored in a memory device attached to a physical stored value card.

Although the data source 108 is shown as being located on, at, or within the computing device 102, it is contemplated that the data source 108 can be located remotely from the computing device 102 in other aspects of the portal 100, such as on, at, or within a database of a data management system or a database of another computing device or system having at least one processor and volatile and/or non-volatile memory.

The computing system 102 may communicate with the computing devices 116, 118, and 120 using a communication network, which can be the Internet, an intranet, or another wired and/or wireless communication network. In one aspect, one or more of the computing system 102 and the computing devices 116, 118, and 120 communicate with one another using any suitable protocol or messaging scheme. For example, the computing system 102 and computing devices 116, 118, and 120 may communicate using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 1A shows the computing system 102 communicating with the computing devices 110, 112, and 114 through a network, other embodiments contemplate the computing system 102 communicating directly with the computing devices 116, 118, and 120 without the use of a separate and a distinct network. Additionally, other embodiments contemplate that the modules employed by the computing system 102 and the computing devices 116, 118, and 120 are integrated in one computing system. Further, the computing devices 116, 118, and 120 alternatively may communicate with the portal computing system 102 via the network.

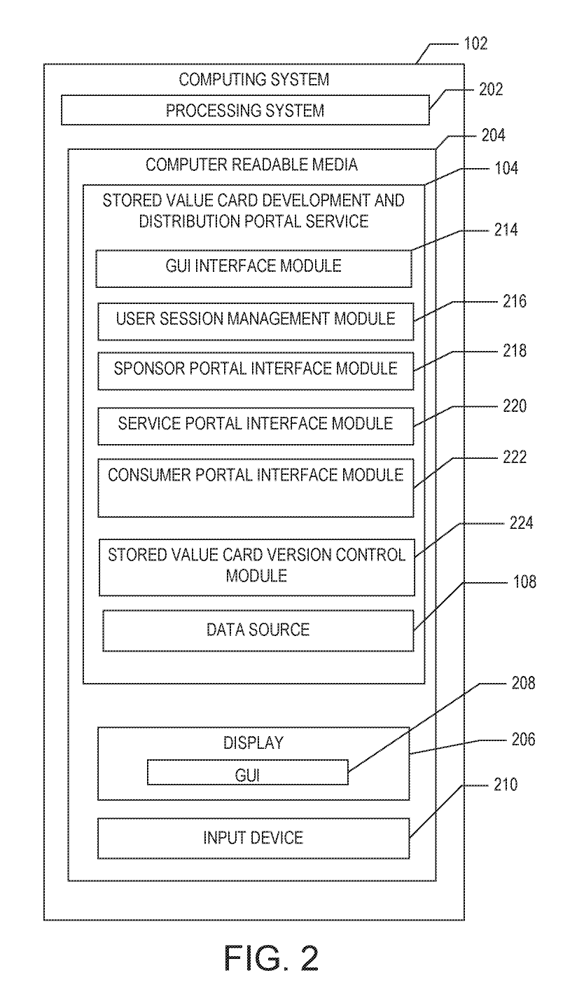

FIG. 2 is a block diagram depicting an example stored value card design and distribution portal service 104 executing on the stored value card design and distribution portal computing system 102. According to one aspect, the stored value card design and distribution portal computing system 102 includes a processing system 202 that includes one or more processors or other processing devices. A processor is hardware. The processing system 202 executes the stored value card design and distribution portal service 104 to generate a GUI on a display of the computing devices 116, 118, and 120 in order to receive customized content for generating the designs 110, and for generating a stored value card to be sent to the consumer. According to another aspect, the stored value card design and distribution portal computing system 102 also includes a display 206, such as a computer monitor, for displaying data and/or a graphical user interface 208. The stored value card design and distribution portal computing system 102 may also include an input device 210, such as a keyboard or a pointing device (e.g., a mouse, trackball, pen, or touch screen) to enter data into or interact with the graphical user interface 228.

Additionally, the GUI 208 may receive user input via the input device 210 to control the operation of the portal computing device 102. For example, an administrator may, from the display 206 and input device 210 of the computing system 102, control the computing system 102 to inhibit or allow certain functionality, perform periodic maintenance on the computing system 102, and/or access one or more log files associated with the operation of the computing system 102.

The stored value card design and distribution portal computing system 102 includes a computer readable media 204 on which the stored value card design and distribution portal service 104 and data source 108 are stored. The stored value card design and distribution portal service 104 includes instructions or modules that are executable by the processing system 202 to generate a customized stored value card design and associated stored value card to be sent to a consumer.

The computer readable media 204 may include volatile media, nonvolatile media, removable media, non-removable media, and/or another available media that can be accessed by the stored value card design and distribution portal computing system 102. By way of example and not limitation, computer readable media 204 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system.

A GUI interface module 214 facilitates the receipt of data and/or other communications from the computing devices 116, 118, and 120. In one example, GUI interface module 214 communicates with the computing devices to generate an interactive display, or other suitable user interface mechanism including one or more selectable fields, editing screens, and the like for receiving instructions and data and activating the card by the host on the GUI 130.

A user session management module 216 establishes, maintains, and cancels login sessions with each sponsor that accesses the portal 100. The user session management module 216 grants certain rights to add, delete, and/or modify content included in each design according to each user. For example, the user session management module 216 allows addition and/or deletion of certain features, such as the addition of a new design version or the deletion of an existing design 110, while restricting other, non-authorized users from performing such procedures.

A sponsor portal interface module 218 communicates, via the sponsor portal interface 106, with the computing device 116 of the sponsor for creating, customizing, and publishing stored value cards that may be purchased by consumers. For example, the sponsor portal interface 206 may receive customized content provided by the sponsor and process the received user-supplied content to generate customized content to be included in the stored value card design 110. For another example, the sponsor portal interface module 218 may receive user selection of a stored value card template 136 including a particular design associated with a special occasion, which is, for example, a birthday, wedding, or a holiday, such as Christmas, Easter, Thanksgiving, and the like.

The user-supplied content may also include for example, content stored in the data source 108, such as pre-recorded audio information from pre-recorded audio files 138, pre-recorded image information from pre-recorded image files 140, and/or pre-recorded video information from pre-recorded video files 142 that may be further manipulated by the sponsor. In a particular embodiment, the user-supplied content includes pre-recorded content including a song or a portion of a pre-recorded song that is copyrighted and licensed by the owner of the copyrighted song. The sponsor portal interface 106 modifies existing content, such as pre-recorded content or other previously received content, based upon input received from the computing device of the sponsor. An example of modifying existing content includes modifying a received photograph using one or more photograph editing features that provides for cropping, color hue adjustment, brightness adjustment, sizing, and/or other features associated with manipulation of digital imagery.

A service portal interface module 220 communicates, via the service portal interface 114, with one or more external systems to provide one or more services for facilitating creation, activation, and/or management of the stored value card designs 110. For example, the service portal interface 220 may communicate with a payment processing server, such as the financial account server 118, to transact a monetary transfer of funds from the financial account of the sponsor for use the portal 100 to manage their stored value card offerings, or with a financial account server 118 of a consumer for activation of a customized stored value card. For another example, the stored value card activation server 116 may be a third party server of a third party stored value card activation service for activation of the stored value card. Examples of such third party stored value card activation service include Incomm™, SVS™, and Store Financial™ stored value card activation services.

A consumer portal interface module 222 communicates, via the consumer portal interface 112, with the computing device 120 of a consumer to facilitate the purchase of a stored value card. In one example, the stored value card is generated in electronic form and transmitted to the recipient via any suitable communication mechanism, such as via an e-mail message, or a short message service (SMS) message. In another example, the stored value card design 110, which has been selected by the consumer, may be transmitted to a production facility 122 for generating a physical stored value card, and sent to the consumer via a mail delivery service, such as the United Parcel Service™ (UPS).

A physical stored value card or an electronic stored value card (e-svc) may be activated. In one embodiment, an e-svc may be generated in digital form and transmitted to the recipient via any suitable communication mechanism, such as via an e-mail message or a short message service (SMS) message. The e-svc may be printable in a form suitable for redemption at a retail outlet of a merchant associated with the e-svc.

A stored value card version control module 224 manages and organizes the stored value card designs 110 stored in the data source 108. In one embodiment, the stored value card version control module 224 may be used for version control. Thus, a sponsor may release ongoing versions that track ongoing changes to the merchandise they sell. For example, the sponsor may have an active close-ended stored value card that is used for a particular product, but would like to make some small modification to correspond with next year's model. Thus, the sponsor could create a new version of the stored value card design 110 and have that new stored value card version become active when the next year's model becomes available. The design portal service 104 may store multiple versions for each merchant so that they can access earlier versions, or do additional market research using the information stored in multiple versions of the merchant's stored value card offerings.

Additionally, the version control module 224 may tag each stored value card design 110 according to one or more status indicators. For example, when a stored value card design 110 is under development, it may be tagged with a pending status indicator, and when the development of the stored value card design has been finalized, it may be tagged with an active status indicator to indicate that the stored value card design 110 is available for purchase.

It should be appreciated that the modules described herein are provided only as an example of a computing device that may execute the stored value card design and distribution portal service 104 according to the teachings of the present invention, and that other computing devices may have the same modules, different modules, additional modules, or fewer modules than those described herein. For example, one or more modules as described in FIG. 2 may be combined into a single module. As another example, certain modules described herein may be encoded and executed on other computing devices, such as the computing devices 116, 118, and 120. Further, one or more or all of the modules may be stored and executed by the stored value card design and distribution portal computing system 102 and data and instructions are transmitted to and from the stored value card design and distribution portal computing system 102 and the computing devices 116, 118, and 120 to execute their functions.

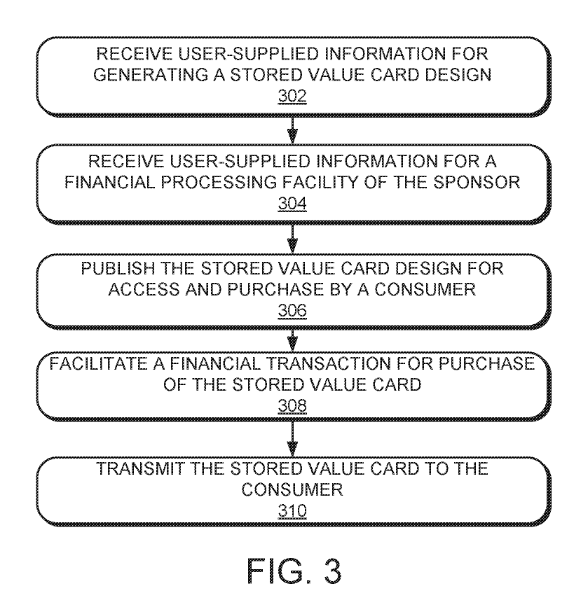

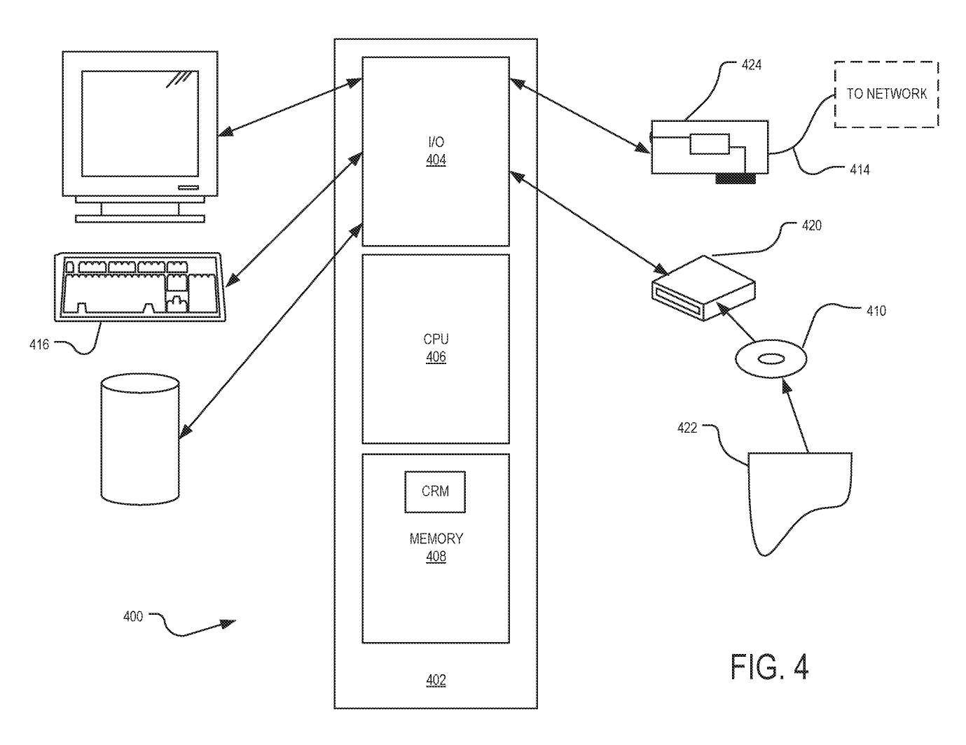

FIG. 3 illustrates an example process 300 that may be performed by the portal service 104 for generating and distributing stored value cards according to one embodiment of the present disclosure.

At step 302, the service 104 receives user-supplied information from a sponsor computing device 116 for creating a customized stored value card design 110. The service 104 may receive selection of a particular template 136 from among multiple stored value card design templates 136. The template 136 generally includes a shell of a completed stored value card design 110 and may include information about the shape of the stored value card design 110, and/or placeholders from which other forms of user-supplied information may be entered. For example, a stored value card design template 136 may have a rectangular shape with a region for entry of a graphic symbol along with one or more regions for entry of alpha-numeric text words or phrases. Additionally, the template 136 may include a region for entry of multi-media, such as sounds, photographs, and/or video information to be included with the stored value card design 110.

In one embodiment, the service 104 may receive user-supplied information for editing existing content on the stored value card design 110. For example, the service 104 may receive user-supplied information for editing the color of a text word or phrase included in the stored value card design 110, or moving the text word or phrase to another region of the template 136.

At step 304, the service 104 receives user-supplied information for associating the stored value card design 110 with a particular processing facility associated with the sponsor. For example, the service 104 may receive information associated with a particular financial account server 118 that manages the finances of the sponsor, such as SVS, First Data, VISA, Mastercard, and the like.

In one embodiment, the service 104 may tag the stored value card design 110 with a particular version such that one of multiple versions of a particular stored value card design 110 may be accessed and manipulated by the sponsor. For example, the sponsor may designate a particular version to be used during the Christmas shopping season, and use another version at other times of the year. As another example, the sponsor may designate a particular version to correspond with a test market study that is being conducted in a particular region of the country while maintaining another separate version to be used by consumers in other regions of the country.

In another embodiment, the service 104 may tag the stored value card design 110 with one of multiple development status indicators. For example, the stored value card design 110 may be tagged with a pending status indicator while development of the stored value card design 110 is underway, and tag the design 110 with an active status when the stored value card design 110 is available for purchase by a consumer. Any type and quantity of status indicators may be tagged on the stored value card design 110. Examples of potential status indicators include a pending status indicator, an in-review status indicator, an approved status indicator, ab active status indicator, a de-activated status indicator, and a market test status indicator.

At step 306, the service 104 publishes the customized stored value card design 110 to be made available for purchase by consumers. The stored value card design 110 may be made available for purchase in any suitable manner. For example, the stored value card design 110 may be compartmentalized in a separate directory or other partitioning device while in development, and moved to another directory when made available for view and purchase by consumers. In one aspect, the directory may function somewhat similar to be a hub or a content delivery network (CDN) that includes multiple stored value card design offerings that are exposed for view and purchase by consumers. In one embodiment, the service 104 may communicate with the consumer portal interface 112 using a RESTful interface.

At step 308, the service 104 facilitates a financial transaction for activation of a stored value card associated with the stored value card design 110 selected by a consumer. For example, the service 104 may communicate, via a service portal interface 114, with a financial account server 118 associated with the consumer, and communicate, via another service portal interface 114, with another financial account server 118 associated with the sponsor for transferal of monetary funds to pay for the stored value card.

At step 310, the service transmits the activated stored value card to the consumer. The stored value card 108 may be generated in digital form (e.g., an e-svc) and transmitted to the recipient via any suitable communication mechanism, such as via an e-mail message, or a short message service (SMS) message, or it may be a physical stored value card that can be transmitted to the consumer via a suitable mail delivery service, such as the United Parcel Service (UPS).

Given the above process described above, a common repository may be provided the development and distribution of the stored value cards in a manner that enhances the reliability, and security of stored value card distribution services. That is, enhanced control over quality and security may be enhanced because the stored value card designs are stored and accessed for sale at a common location. Additionally, ongoing changes performed on the stored value card designs 110 may be applied in a structured organized manner due to the versioning system.

The process 300 described above may be repeatedly performed to develop and distribute other stored value card designs 110 for purchase by consumers. Nevertheless, when use of the service 104 is no longer needed or desired, the process ends.

FIG. 2 illustrates a general purpose computing system 200 that may implement various systems, such as the computing system 108 of FIG. 1. A general purpose computer system 200 is capable of executing a computer program product to execute a computer process. Data and program files may be input to the computer system 200, which reads the files and executes instructions, such as those that may be used to implement the features of the exercise pacing device 100 as described herein above. Some of the elements of a general purpose computer system 200 are shown in FIG. 2 wherein a processor 202 is shown having an input/output (I/O) section 204, a central processing unit (CPU) 206, and a memory section 208. There may be one or more processors 202, such that the processor 202 of the computer system 200 comprises a single central-processing unit 206, or a plurality of processing units, commonly referred to as a parallel processing environment. The computer system 200 may be a conventional computer, a computing system, a distributed computer, or any other type of computer, such as one or more external computers made available via a cloud computing architecture. The presently described technology is optionally implemented in software devices loaded in memory 208, stored on a configured DVD/CD-ROM 210 or storage unit 212, and/or communicated via a wired or wireless network link 214, thereby transforming the computer system 200 in FIG. 2 to a special purpose machine for implementing the described operations.

The memory section 208 may be volatile media, nonvolatile media, removable media, non-removable media, and/or other media or mediums that can be accessed by a general purpose or special purpose computing device. For example, the memory section 208 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 204 is connected to one or more user-interface devices (e.g., a keyboard 216 and a display unit 218), a disc storage unit 212, and a disc drive unit 220. Generally, the disc drive unit 220 is a DVD/CD-ROM drive unit capable of reading the DVD/CD-ROM medium 210, which typically contains programs and data 222. Computer program products containing mechanisms to effectuate the systems and methods in accordance with the presently described technology may reside in the memory section 204, on a disc storage unit 212, on the DVD/CD-ROM medium 210 of the computer system 200, or on external storage devices made available via a cloud computing architecture with such computer program products, including one or more database management products, web computing system products, application computing system products, and/or other additional software components. Alternatively, a disc drive unit 220 may be replaced or supplemented by some other storage medium drive unit. The network adapter 224 is capable of connecting the computer system 200 to a network via the network link 214, through which the computer system can receive instructions and data. Examples of such systems include personal computers, Intel or PowerPC-based computing systems, AMD-based computing systems, ARM-based computing systems, and other systems running a Windows-based, a UNIX-based, a mobile operating system, or other operating system. It should be understood that computing systems may also embody devices such as mobile phones, tablets or slates, multimedia consoles, gaming consoles, set top boxes, etc.

When used in a LAN-networking environment, the computer system 200 is connected (by wired connection and/or wirelessly) to a local network through the network interface or adapter 224, which is one type of communications device. When used in a WAN-networking environment, the computer system 200 typically includes a modem, a network adapter, or any other type of communications device for establishing communications over the wide area network. In a networked environment, program modules depicted relative to the computer system 200 or portions thereof, may be stored in a remote memory storage device. It is appreciated that the network connections shown are examples of communications devices for and other means of establishing a communications link between the computers may be used.

In an example implementation, source code executed by the computing system 108 and/or the wireless device 112 may be stored in memory of the computing system 108 or memory of the wireless device 112 including a data source 212, or other storage systems, such as the disk storage unit 212 or the DVD/CD-ROM medium 210, and/or other external storage devices made available and accessible via a network architecture. The source code executed by the computing system 108 and the wireless device 112 may be embodied by instructions stored on such storage systems and executed by the processor 202.

Some or all of the operations described herein may be performed by the processor 202, which is hardware. Further, local computing systems, remote data sources and/or services, and other associated logic represent firmware, hardware, and/or software configured to control operations the system 100 and/or other components. Such services may be implemented using a general purpose computer and specialized software (such as a computing system executing service software), a special purpose computing system and specialized software (such as a mobile device or network appliance executing service software), or other computing configurations. In addition, one or more functionalities disclosed herein may be generated by the processor 202 and a user may interact with a Graphical User Interface (GUI) using one or more user-interface devices (e.g., the keyboard 216, the display unit 218, and the user devices 204) with some of the data in use directly coming from online sources and data stores. The system set forth in FIG. 2 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., hard disk drive), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A stored value design and distribution portal comprising:
a computing system comprising at least one memory for storing instructions that, when executed by at least one processor, are executed to:
expose a sponsor portal interface for receiving user supplied information for customizing a stored value card from a sponsor of the stored value card;
generate a stored value card design using the user supplied information, the stored value card design being stored in a repository;
publish, using one or more second portal interfaces, the stored value card design for purchase as a stored value card by a consumer from the repository, wherein the stored value card is published from the repository that is the same repository used to customize the stored value card; and
transmit the stored value card to the consumer.

2. The stored value design and distribution portal of claim 1, wherein the repository used to store the generated stored value card is the same repository that is used to publish the stored value card design for purchase by the consumer.

3. The stored value design and distribution portal of claim 1, wherein the portal is managed by an entity that is separate and distinct from the sponsor of the stored value card.

4. The stored value design and distribution portal of claim 1, further comprising a service portal interface, wherein the instructions are further executed to conduct a financial transaction for the stored value card by exposing the service portal interface to a financial account server associated with the consumer, wherein the stored value card is accessed from the repository that is the same repository used to customize the stored value card.

5. The stored value design and distribution portal of claim 1, wherein at least one of the sponsor portal interface, the service portal interface, or the consumer portal interface comprises an application program interface (API).

6. The stored value design and distribution portal of claim 1, wherein the instructions are further executed to store the stored value card in the repository according to one of a plurality of versions.

7. The stored value design and distribution portal of claim 1, wherein the instructions are further executed to store the stored value card in the repository according to one of a plurality of development status indicators, the development status indicators comprising at least one of a pending status indicator, an in-review status indicator, an approved status indicator, ab active status indicator, a de-activated status indicator, and a market test status indicator.

8. A stored value design and distribution portal method comprising:
exposing, using executable instructions stored in a non-transitory medium and executed on at least one processor, a sponsor portal interface for receiving user supplied information for customizing a stored value card from a sponsor of the stored value card;
generating, using the instructions, a stored value card design using the user supplied information, the stored value card design being stored in a repository;
publishing, using the instructions, using one or more second portal interfaces, the stored value card design for purchase as a stored value card by a consumer from the repository, wherein the stored value card is published from the repository that is the same repository used to customize the stored value card; and
transmitting, using the instructions, the stored value card to the consumer.

9. The stored value design and distribution portal method of claim 8, further comprising storing the stored value card design in the same repository that is used to publish the stored value card design for purchase by the consumer.

10. The stored value design and distribution portal method of claim 8, further comprising managing the portal by an entity that is separate and distinct from the sponsor of the stored value card.

11. The stored value design and distribution portal method of claim 8, further comprising conducting a financial transaction for the stored value card by exposing a service portal interface to a financial account server associated with the consumer, wherein the stored value card is accessed from the repository that is the same repository used to customize the stored value card.

12. The stored value design and distribution portal method of claim 8, wherein at least one of the sponsor portal interface, the service portal interface, or the consumer portal interface comprises an application program interface (API).

13. The stored value design and distribution portal method of claim 8, further comprising storing the stored value card in the repository according to one of a plurality of versions.

14. The stored value design and distribution portal method of claim 8, further comprising storing the stored value card in the repository according to one of a plurality of development status indicators, the development status indicators comprising at least one of a pending status indicator, an in-review status indicator, an approved status indicator, ab active status indicator, a de-activated status indicator, and a market test status indicator.

15. Code implemented in a non-transitory, computer readable medium that when executed by at least one computing unit, is operable to perform at least the following:
exposing a sponsor portal interface for receiving user supplied information for customizing a stored value card from a sponsor of the stored value card;
generating a stored value card design using the user supplied information, the stored value card design being stored in a repository;
publishing, using one or more second portal interfaces, the stored value card design for purchase as a stored value card by a consumer from the repository, wherein the stored value card is published from the repository that is the same repository used to customize the stored value card; and
transmitting the stored value card to the consumer.

16. The code of claim 15, further executed to store the stored value card design in the same repository that is used to publish the stored value card design for purchase by the consumer.

17. The code of claim 15, further executed to manage the portal by an entity that is separate and distinct from the sponsor of the stored value card.

18. The code of claim 15, further comprising conducting a financial transaction for the stored value card by exposing a service portal interface to a financial account server associated with the consumer, wherein the stored value card is accessed from the repository that is the same repository used to customize the stored value card.

19. The code of claim 15, further executed to store the stored value card in the repository according to one of a plurality of versions.

20. The code of claim 15, further executed to store the stored value card in the repository according to one of a plurality of development status indicators, the development status indicators comprising at least one of a pending status indicator, an in-review status indicator, an approved status indicator, ab active status indicator, a de-activated status indicator, and a market test status indicator.
